(19) United States
(12) Patent Application Publication
(10) Pub. No.: US 2013/0094594 A1
(43) Pub. Date: Apr. 18, 2013

(54) METHOD FOR CONFIGURING AND TRANSMITTING M-UNIT

(71) Applicant: Electronics and Telecommunications Research In, Daejeon (KR)

(72) Inventor: Seong Jun BAE, Daejeon (KR)

(73) Assignee: Electronics and Telecommunications Research Institute, Daejeon (KR)

(21) Appl. No.: 13/651,191

(22) Filed: Oct. 12, 2012

(30) Foreign Application Priority Data
Oct. 13, 2011 (KR) 10-2011-0104854
Oct. 12, 2012 (KR) 10-2012-0113531

(51) Int. Cl. H04N 7/26

(52) U.S. Cl. 375/240.26; 375/E07.2

(57) ABSTRACT

A method for configuring and transmitting an M-unit in a system are provided. The method for configuring an M-unit in a system includes receiving an MFU (Media Fragment Unit) from a media encoder, and configuring an M-unit including the MFU in payload, wherein the M-unit is configured to include an M-unit header including information required to be discriminated in every M-unit and a reference header including information not dependent on the M-unit.

Priority to Korean patent application number 10-2011-0104854 filed on Oct. 13, 2011 and 10-2012-0113531 filed on Oct. 12, 2012, the entire disclosure of which is incorporated by reference herein, is claimed.

### BACKGROUND OF THE INVENTION

1. Field of the Invention

The present invention relates to an M-unit of an MMT (MPEG Media Transport) and, more particularly, to a method and apparatus for configuring or transmitting an M-unit.

2. Related Art

Recently, ISO/IEC JTC1/SC29/WG11 (referred to as ‘MPEG’ hereinafter) is standardizing MPEG-H, a multimedia coding representation and multiplex transfer standard to be used in an UHDTV (Ultra-High-Definition TV) era in the future. Similar to the existing system such as MPEG-1, MPEG-2, MPEG-4, and the like, MPEG-H is comprised of systems such as Part 1 system, Part 2 video, and Part 3 audio, and the like, and due to be published as a set of standards. Part 1 of MPEG-H is MMT (MPEG Media Transport), Part 2 is HEVC (High-Efficiency Video Coding), and Part 3 is not decided yet but anticipated to be a next-generation audio compression coding standard, and the like, to be standardized for UHDTV in an MPDG audio subgroup after USAC (Universal Speech and Audio Coding). The MMT is a next-generation multimedia multiplexing transfer standard under standardization in MPEG, as a follow-up of MPEG-2 TS (Transport Stream), and HEVC is a next-generation video compression coding standard in consideration of its application to UHDTV under standardization by ISO and ITU-T in cooperation.

The MT is IP-friendly and aims at transferring multimedia using various types of channels. The MMT is comprised of an encapsulation (E) function, a delivery (D) function, and a control (C) function. Multimedia contents is packed as a single entity through the E function, the packed contents is packetized according to an IP protocol through the D function, and various types of control information to including multimedia service search information is transferred through the C function.

Currently, many enterprises and schools in Korea are participating in the MMT standardization, and techniques are proposed in all the specific fields of the MMT. In particular, a method for transmitting and receiving an M-unit having a novel structure in the MMT is required.

### SUMMARY OF THE INVENTION

The present invention provides a method and apparatus for configuring an M-unit having a novel structure.

The present invention also provides a method and apparatus for transmitting an M-unit having a novel structure.

In an aspect, a method for configuring an M-unit in a system includes: receiving an MFU (Media Fragment Unit) from a media encoder; and configuring an M-unit including the MFU in payload, wherein the M-unit is configured to include an M-unit header including information required to be discriminated in every M-unit and a reference header including information not dependent on the M-unit.

In another aspect, a method for transmitting an M-unit in a system includes: receiving an MFU (Media Fragment Unit) from a media encoder; configuring an M-unit including the MFU in payload such that the M-unit includes an M-unit header including information required to be discriminated in every M-unit and a reference header including information not dependent on the M-unit; and transmitting the M-unit.

According to embodiments of the present invention, an M-unit including a to reference header may perform compression (or archiving) and transporting by discriminating a header. Also, in the M-unit including a reference header, there is no need to attach a field repeated several times to each unit, and when it is delivered before a corresponding unit, it may be sent to a certain position. Also, a retransmission policy may be independently executed on a packet error, and out-of-band transmission, as well as in-band transmission, may be performed.

### BRIEF DESCRIPTION OF THE DRAWINGS

FIG. 1 is a view illustrating an example of a structure of a reference header according to an embodiment of the present invention.

FIG. 2 is a view illustrating an example of a method for aggregating a plurality of MFUs according to an embodiment of the present invention.

### DESCRIPTION OF EXEMPLARY EMBODIMENTS

Hereinafter, embodiments will be described in detail with reference to the accompanying drawings such that they can be easily practiced by those skilled in the art to which the present invention pertains. However, the present invention may be implemented in various forms and not limited to the embodiments disclosed hereinafter. Also, in order to clarify the present invention, parts irrespective of description will be omitted, and similar reference numerals are used for the similar parts throughout the specification.

An M-unit is a basic unit for performing a follow-up process after a system (e.g., a multimedia system) receives an MFU (Media Fragment Unit).

The MFU is an output of a media encoder (e.g., a video encoder or an audio encoder). Here, through a header of the MFU, information generated in the media encoder is transferred to the system. The header of the MFU is used as a passage for transferring information helpful to a system operation (e.g., transmitting or storing information or a signal) among information the media encoder has or knows. The MFU is an output of the media encoder comprised of encoding data (e.g., audio data or video data) and an MFU header.

A basic operation in relation to an M-unit includes 1) an operation of discriminating a plurality of MFUs in case that the M-unit includes the plurality of MFUs, 2) an operation of discriminating AUs (Access Units) within the M-unit, 3) an operation of transmitting or discriminating time information such as CTS (Composition Time Stamp)/DTS (Decode Time Stamp) of an encapsulation layer level of each AU when the M-unit is a timed M-unit, and the like. Here, CTS refers to a time during which a corresponding MFU is displayed on a screen, and the DTS refers to a time during which the corresponding MFU is consumed in a decoder.

Hereinafter, a structure of the M-unit according to an embodiment of the present invention will be described. In detail, 1) a structure and a purpose of a reference header, 2) aggregation of a plurality of MFUs, 3) discrimination of AUs, and 4) timestamp information will be described. A system (e.g., a multimedia system) may configure an M-unit to have the following structure. Also, the system may transmit the configured M-unit to a different system or a different device.

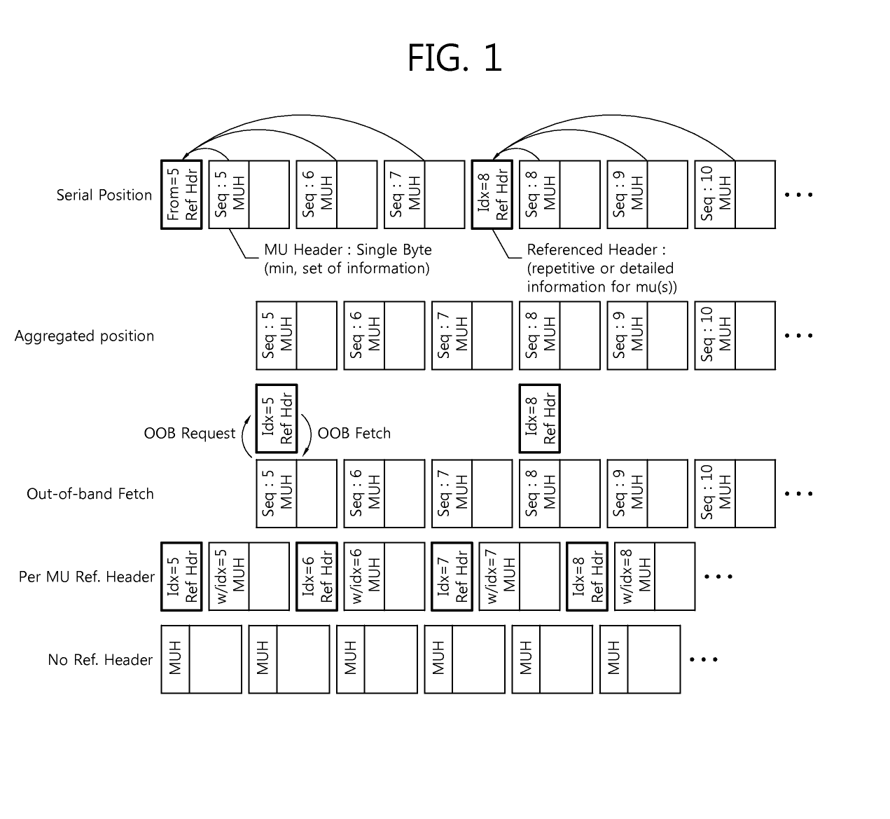

FIG. 1 illustrates an example of a structure of a reference header according to an embodiment of the present invention.

Referring to FIG. 1, a header of an M-unit according to an embodiment of the present invention may have a two-staged header structure including a reference header (RH). For example, it may have a two-staged structure including a reference header and an M-unit header.

Essential information repeated in every payload is left at the front of the payload (this is called a first stage header), and the remainder of the information may be separated as another header called a reference header (this is called a second stage header).

Here, the reference header may exist as a unit separate from a payload unit. Also, when the reference header is temporally before the M-unit to be used, it may be sent to a certain timing (namely, the reference header is not necessarily positioned to be immediately before the M-unit). Also, the reference header may freely select an in-band transmission and an out-of-band transmission.

Also, the reference header is information required for the M-unit level, but it may include information not required to be discriminated in every M-unit or may include information not required to be dependent on a particular M-unit, while, unlike the reference header, a prefix MU-header (MUH) may include information required to be discriminated in every M-unit. The M-unit may optically include a reference header, and it may not necessarily include the reference header.

For example, the M-unit may have a structure in which a reference header (RH) and an M-unit header (MUH) are arranged in series. This may be called a serial position 110.

In another example, the M-unit may have a structure in which both the RH and the MUH are positioned in front of payload. This is called an aggregated position 120.

In another example, the M-unit may have a structure of performing out-of-band transmission with the RH. This may be called an out-of-band (OOB) fetch 130. The MUH may request an OOB from the RH, and the RH may perform to OOB fetch on the MUH.

In another example, the M-unit may have a structure 140 in which an RH is included in every M-unit (or payload of every M-unit). Namely, RH and MUH may correspond in a one-to-one manner.

In another example, the M-unit may have a structure 150 not including an RH.

The M-unit including a reference header as described above may perform archiving and transmitting through discrimination of a header. In general, in case of a file archiving application, a form in which header information items are positioned collectively in one place is preferred, and in case of a transmission application, interleaved positioning of header information between packet streams of a required part is preferred.

Also, in case of an M-unit including a reference header, there is no need to attach a field repeated several times to every unit. If it is delivered before a corresponding unit, it may be sent to a certain position.

Also, the M-unit including a reference header may independently implement a re-transmission policy with respect to a packet error.

Also, the M-unit including a reference header is available for out-of-band transmission, as well as for in-band transmission.

Meanwhile, among methods of extending a header to include various types of information in the header, a method of extending a header according to a bit option like M2TS cannot implement a re-transmission policy with respect to the header and does not have flexibility of sending to a certain position. Also, a header cannot be transmitted by out-of-bound (OOB).

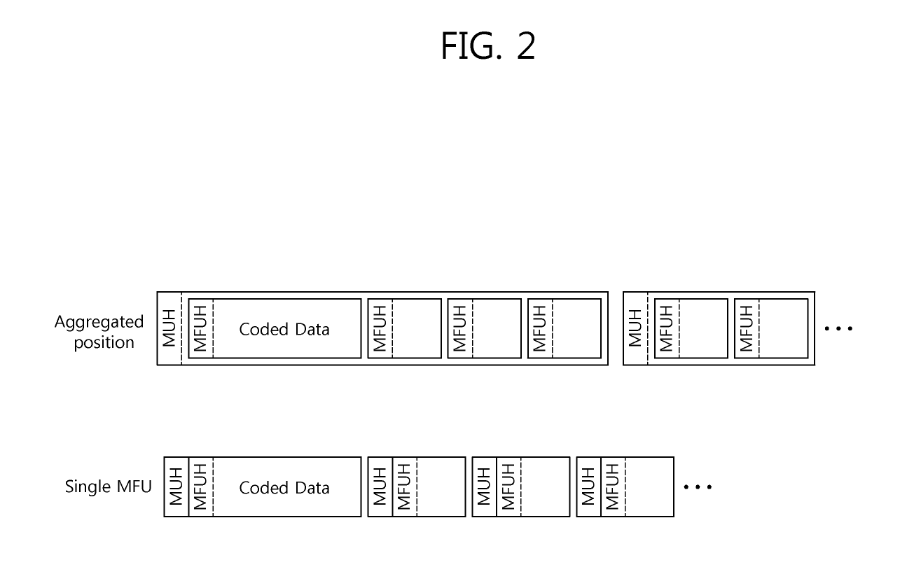

FIG. 2 is a view illustrating an example of a method of aggregating a to plurality of MFUs according to an embodiment of the present invention.

Referring to FIG. 2, an M-unit has a structure in which two or more MFUs are included in one MU.

A system may select whether to aggregate two or more MFUs in a single payload M-unit. A specific description for aggregating MFUs is included in an RH, rather than in an MHU. The reason for this is because the size of the description of several MFUs is too large to be directly included in the MUH, a media having a simple structure has the same MU structure (or even the sizes of MFUs within an MU are equal) in many cases, and in this case, it is not necessary for every M-unit to have a dedicated description.

Meanwhile, according to an embodiment of the present invention, the MFUs included in an MU may be discriminated by AU. Here, an AU (e.g., an MPEG AU) is the smallest data entity in which timing information is transferred, and is the smallest unit sharing the same time information, so it is very important to identify AUs in a media-related system for which processing by time unit is critical. Also, an MU may include an AU start/end indicator, and the indicator may indicate an AU in which an MFU starts, an AU in which an MFU is terminated, or a number of AU or the number of AUs.

Meanwhile, according to an embodiment of the present invention, the M-unit may further include timestamp information.

With respect to MFUs included in the M-unit, the system may provide CTS and DTS information in order to provide time information of a screen configuration thereof. Here, the CTS and DTS information provides a constant mode, and a DTS field may be selectively used. Also, the CTS and DTS values may be described in an MFU unit. When the constant mode is used, an additional to description may be included in a reference header. For example, a starting point of a CTS or an incremental gap may be included in the reference header.

Hereinafter, syntax and semantics of an M-unit according to an embodiment of the present invention will be described.

As mentioned above, a header of an M-unit includes a reference header (RH) and a payload type (MHU).

Table 1 below shows an example of syntax and semantics of an M-unit according to an embodiment of the present invention. The components hereinafter are not limited to order, and all the components are not necessarily included and only some of them may be included.

TABLE 1

| Syntax | No. of bits | Mnemonic |
|---|---|---|
| m_unit ( ){ | | |
| MU_type | 2 | bslbf |
| if (MU_type != ‘00’) { | | |
| mu_base_header ( ) /* Min. set of Header */ | | |
| mu payload ( ) | | |
| } | | |
| else { | | |
| reserved | 6 | bslbf |
| mu_reference_header ( ) | | |
| } | | |
| } | | |

Table 1 shows the number of PDCCH candidates to be monitored by a UE.

Here, MU_type designates a reference header usage mode of an M-unit, which may be comprised of, for example, 2 bits. Table 2 below shows an example of a bit configuration of the MU_type. The components hereinafter are not limited to order, and all the components are not necessarily included and only some of them may be included.

TABLE 2

| MU_type | Name | Semantics |
|---|---|---|
| 00 | Reference | Content of M-unit is reference header |
| | Header | |
| 01 | M-Unit Payload | M-unit does not use reference header. |
| | with No | M-unit is comprised of a single MFU, |
| | Referenced | and uses “Full descriptive timestamp |
| | Header | mode” |
| 10 | M-Unit Payload | M-unit uses reference header. Reference |
| | with In-band | header referred to by M-unit is trans- |
| | Referenced | mitted in the same stream as a packet |
| | Header | stream in which M-unit is transmitted |
| 11 | M-Unit Payload | M-unit uses reference header, and ref- |
| | With Out-of-band | erence header referred to by M-unit is |
| | Referenced | transmitted in a transport channel different |
| | Header | from a packet stream in which M-unit is |
| | | transmitted. The different transport channel |
| | | may be a separate UDP stream, a separate |
| | | TCP channel, or a file form. |

Table 3 below shows an example of syntax and semantics of an M-unit to base header. An M-unit base header refers to a header which is not a reference header among M-unit headers. Here, the M-unit base header may be positioned in front of a payload type M-unit. The components hereinafter are not limited to order, and all the components are not necessarily included and only some of them may be included.

TABLE 3

| Syntax | No. of bits | Mnemonic |
|---|---|---|
| mu_base_header ( ){ | | |
| flag_multiple_MFU | 1 | bslbf |
| flag_random_access_point | 1 | bslbf |
| flag_timed | 1 | bslbf |
| flag_constant_CTS | 1 | bslbf |
| flag_DTS_by_CTS | 1 | bslbf |
| reserved | 1 | bslbf |
| If(MU type != ‘01’){ | | |
| pl_seqno | 16 | uimsbf |
| } | | |
| } | | |

Here, when flag_multiple_MFU has a value ‘1’, it indicates that an M-unit has two or more MFUs, and when flag_multiple_MFU has a value ‘0’, it indicates that the M-unit has only a single MFU. Preferably, MFU aggregation may be used in a lossless environment (e.g., in a lossless transport channel such as a TCP or a local file manipulation).

Also, when flag_random_access_point has a value ‘1’, it indicates that an M-unit includes an MFU starting with a random access point of a media among MFUs.

Also, when flag_timed has a value ‘1’, it indicates that an M-unit includes timed media data. Here, the timed media refers to media data (e.g., an audio frame or a video frame) in which time to be consumed is designated by a particular time. When flag_timed has a value ‘0’, it indicates that an M-unit includes non-timed media data. Here, the non-timed media data refers to media is data in which time to be consumed is not specified.

Also, when flag_constant_CTS has a value ‘1’, it indicates that an AU belonging to an M-unit operates in a constant mode. Here, the constant mode is a mode refers to a mode in which a time interval between AUs of every M-unit belonging to the corresponding mode is uniform, and a starting value and the time interval is informed by a reference header. When flag_constant_CTS has a value ‘0’, it indicates that an AU belonging to the corresponding M-unit operates in a full descriptive mode. Here, the full descriptive mode is a mode in which a dedicated CTS value is explicitly written with respect to every AU of every M-unit belonging to the corresponding mode.

When flag_DTS_by_CTS has a value ‘1’, it indicates that a DTS value of an AU of a corresponding M-unit and a CTS value of the same AU are identical. The corresponding M-unit does not separately have a header field corresponding to the DTS. When flag_DTS_by_CTS has a value ‘0’, it indicates that every AU of the corresponding M-unit has a dedicated DTS value.

Regarding pl_seqno, when a reference header mode (ref_header_mode) has a value ‘01’ or ‘10’, the M-unit uses a reference header, and a sequence number is provided to designate a corresponding M-unit (or a group of the M-unit) in each section of the reference header. Here, pl_seqno has a value increased by 1 each time in each M-unit with respect to an M-unit stream, and in this case, pl_seqno is increased only for a payload type M-unit and does not count a reference header that may exist midway.

Table 4 below shows an example of syntax and semantics of a payload type M-unit. The components hereinafter are not limited to order, and all the components are not necessarily included and only some of them may be included.

TABLE 4

| Syntax | No. of bits | Mnemonic |
|---|---|---|
| mu_payload ( ){ | | |
| for(i=0; i<no_of_media_fragment_unit; i++){ | | |
| if(flag_timed == ‘1’){ | | |
| if(flag_constant_CTS == ‘0’){ | | |
| CTS | 32 | uimsbf |
| } | | |
| if(flag_DTS_by_CTS == ‘0’){ | | |
| DTS | 32 | uimsbf |
| } | | |
| } | | |
| if(‘Decoder is MMT unaware’){ | | |
| mfu_header ( ) | | |
| } | | |
| media_fragment_unit ( ) | | |
| } | | |
| } | | |

Here, CTS (Composition Time Stamp) refers to a time during which a corresponding MFU is displayed on a screen. DTS (Decode Time Stamp) refers to a time during which a corresponding MFU is consumed in a decoder.

A reference header of an M-unit may include one or more sections, and each section may have a unique section ID.

The system may adjust the number of reference headers of an M-unit as necessary, and may arbitrarily select a type of a section included in each reference header.

Table 5 below shows an example of a reference header of an M-unit. The components hereinafter are not limited to order, and all the components are not necessarily included and only some of them may be included.

TABLE 5

| Syntax | No. of bits | Mnemonic |
|---|---|---|
| mu_reference_header ( ){ | | |
| while(i=0;i<N;i++){ | | |
| section_ID | 16 | uimsbf |
| section_byte_length | 16 | uimsbf |
| start_pl_seqno | 16 | uimsbf |
| if(section_ID == 0x0000){ /*refhdr root | | |
| description*/ | 16 | uimsbf |
| no_of_section | | |
| for(i=0; i<no_of_section; i++){ | 16 | uimsbf |
| section_ID_used | | |
| } | | |
| } | | |
| else if(section_ID == 0x0001){ /*timestamp | | |
| descr.*/ | 32 | uimsbf |
| base_CTS | 16 | uimsbf |
| CTS_increment | | |
| } | | |
| └ else if(section_ID == 0x0002){ /*aggr. | | |
| description*/ | 16 | uimsbf |
| no_of_media_fragment_unit | | |
| for(i=0; | 32 | uimsbf |
| i<no_of_media_fragment_unit; i++){ | 32 | uimsbf |
| MFU_byte_offset | | |
| MFU_byte_size | | |
| } | | |
| } | | |
| else if(section_ID >= 0x8000 && | | |
| section_ID <= 0xffff){ | | |
| mu_refhdr_userdef( ) /*Defined by | | |
| appl.*/ | | |
| } | | |
| } | | |
| } | | |

Here, in relation to a section ID, a reference header of an M-unit may be divided into several sections according to information desired to be provided, and a section ID is an ID for discriminating sections and may have, for example, a 2-byte unsigned integer format. A corresponding operation may be given in advance according to a number of a section ID, or a user may freely allocate and use a number of a section ID according to the necessity of an application.

Table 5 below shows an example of initial numbering of a section ID according to an embodiment of the present invention. The components hereinafter are not limited to order, and all the components are not necessarily included and only some of them may be included.

TABLE 6

| Section ID | operation | description |
|---|---|---|
| 0x0000 | Reference Header Root | A single M-unit stream may use several reference header |
| | Description | sections as necessary, and these sections may be dividedly |
| | | disposed in two or more reference headers as necessary. It |
| | | indicates a section ID in advance used in an entire M-unit |
| | | stream. |
| | | When an M-unit stream uses a reference header, a system |
| | | essentially reads this section before proceeding from a |
| | | starting stage to a next stage. |
| | | It is a section allowing for recognizing which section an M- |
| | | unit stream uses. |
| 0x0001 | Timestamp Description | It is a section providing constant timestamp related |
| | | information when an M-unit uses a constant timestamp mode. |
| | | Information described in the corresponding section is valid for |
| | | an M-unit corresponding to mu_seqno from |
| | | start_mu_seqno of a present timestamp description to |
| | | start_mu_seqno-1 of a next timestamp description. |
| 0x0002 | Multiple MFU | It is a section referred to by an M-unit when the M-unit |
| | Aggregation Description | includes two or more multiple MFUs. |
| | | The corresponding section and the M-unit are coupled by |
| | | start_mu_seqno and seq_no of the M-unit. |
| 0x0003 | Dependency | It is a section describing a dependency relationship when |
| | Description | there is a dependency relationship between M-units or |
| | | groups of M-units. |
| 0x0004~ | (TBD/Reserved) | — |
| 0x7fff | | |
| 0x8000~ | User Defined | It is a section arbitrarily selected and used by a user |
| 0xffff | | according to an application. |

Here, section_byte_length indicates a size of a corresponding section and may have a byte unit. Here, the size of the section may include a section ID, section_byte_length, or a size of a start_mu_seqno field.

Also, start_mu_seqno indicates a position of an M-unit in an M-unit stream to which a corresponding section is to be applied, as a sequence number of the M-unit. Thus, an M-unit of an M-unit stream using a reference header has a sequence number.

Also, no_of_section indicates the number of all the sections used in the M-unit stream. Also, section_ID_used indicates a section ID used in the M-unit stream. Here, no_of_section and section_ID_used may be used when a section ID is ‘0x0000’.

Also, base_CTS is a starting CTS value of a starting M-unit with respect to an M-unit using a constant timestamp mode. CTS_increment indicates an increment (AU unit) of CTS with respect to an M-unit using the constant timestamp mode. Also, base_CTS and CTS_increment may be used when a section ID is ‘0x0001’.

Also, no_of_media_fragment_unit indicates the number of MFUs when one M-unit includes two or more MFUs. MFU_byte_offset indicates a byte offset value of a current MFU from starting of the M-unit in order to MFUs constituting the M-unit. MFU_byte_size indicates a byte size of a current MFU in order of the MFUs constituting the M-unit. Here, no_of_media_fragment_unit and MFU_byte_offset MFU_byte_size may be used when a section ID is ‘0x0002’.

In the exemplary system as described above, the methods are described based on the flow chart by sequential steps or blocks, but the present invention is not limited to the order of the steps, and a step may be performed in different order from another step as described above or simultaneously performed. It would be understood by a skilled person in the art that the steps are not exclusive, a different step may be included, or one or more of the steps of the flow chart may be deleted without affecting the scope of the present invention.

As the exemplary embodiments may be implemented in several forms without departing from the characteristics thereof, it should also be understood that the above-described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

What is claimed is:

1. A method for configuring an M-unit in a system, the method comprising:
receiving an MFU (Media Fragment Unit) from a media encoder; and
configuring an M-unit including the MFU in payload,
wherein the M-unit is configured to include an M-unit header including information required to be discriminated in every M-unit and a reference header including information not dependent on the M-unit.

2. The method of claim 1, wherein the reference header and the M-unit header are arranged in series.

3. The method of claim 1, wherein the reference header and the M-unit header are aggregated in front of the payload.

4. The method of claim 1, wherein the reference header is set as an out-of-band of the M-unit, and
the M-unit header performs a out-of-band transmission request on the reference header, and the reference header performs a out-of-band fetch on the M-unit header.

5. The method of claim 1, wherein the M-unit includes one reference header in every payload.

6. The method of claim 1, wherein the M-unit includes a plurality of MFUs, and the method further comprising:
selecting whether to aggregate the plurality of MFUs in a single M-unit.

7. The method of claim 6, wherein the reference header includes a description for aggregating the plurality of MFUs.

8. The method of claim 1, wherein the MFUs are discriminated by an AU (Access Unit) as the smallest data entity in which timing information is transferred.

9. The method of claim 8, wherein the M-unit further includes an AU starting indicator indicating an AU in which the MFU starts and an AU end indicator indicating an AU in which the MFU is terminated.

10. The method of claim 9, wherein the AU starting indicator indicates a number of the AU in which the MFU starts, and the AU end indicator indicates a number of the AU in which the MFU is terminated.

11. The method of claim 1, wherein the M-unit further includes timestamp information including a CTS (Composition Time Stamp) indicating a time during which the MFU is displayed on a screen and a DTS (Decode Time Stamp) indicating a time during which the MFU is consumed in a decoder.

12. The method of claim 11, wherein the CTS or the DTS provides a constant mode in which time intervals between AUs of the M-unit is uniform, and
the CTS or the DTS are described by MFU units.

13. The method of claim 12, wherein when the constant mode is used, the reference header further includes a starting point or incremental gaps of the CTS.

14. A method for transmitting an M-unit in a system, the method comprising:
receiving an MFU (Media Fragment Unit) from a media encoder;
configuring an M-unit including the MFU in payload such that the M-unit includes an M-unit header including information required to be discriminated in every M-unit and a reference header including information not dependent on the M-unit; and
transmitting the M-unit.

15. The method of claim 14, wherein the reference header and the M-unit header are arranged in series.

16. The method of claim 14, wherein the reference header and the M-unit header are aggregated in front of the payload.

17. The method of claim 14, wherein the reference header is set as an out-of-band of the M-unit, and
the M-unit header performs a out-of-band transmission request on the reference header, and the reference header performs a out-of-band fetch on the M-unit header.

18. The method of claim 14, wherein the M-unit includes one reference header in every payload.

19. The method of claim 14, wherein the M-unit includes a plurality of MFUs, and the method further comprising:
selecting whether to aggregate the plurality of MFUs in a single M-unit.

20. The method of claim 19, wherein the reference header includes a description for aggregating the plurality of MFUs.
